(19) United States
(12) Patent Application Publication
(10) Pub. No.: US 2015/0206233 A1
(43) Pub. Date: Jul. 23, 2015

(54) METHOD AND SYSTEM FOR WIRELESS PROPERTY RELATED FINANCIAL CALCULATION

(71) Applicant: Todd Alan Kuhlmann, Austin, TX (US)

(72) Inventor: Todd Alan Kuhlmann, Austin, TX (US)

(21) Appl. No.: 14/158,848

(22) Filed: Jan. 19, 2014

(51) Int. Cl. G06Q 40/00; G06F 17/30; H04W 8/24; G06Q 50/16

(52) U.S. Cl. CPC G06Q 40/00; G06Q 50/16; G06F 17/30386; G06F 17/30312; H04W 8/24

(57) ABSTRACT

A system and method for wireless property related financial calculations using a communication network comprising: a wireless user display device communicating over the network with a server and the server conducting the financial calculations for generating financial calculation report in a user defined document format, such as, but not limited to, portable document format (PDF), HTML, or other electronic document for easy reading and sharing by the user. The server conducts the requested analysis by using pre stored financial calculation programs related to requested financial calculation. The system of the present invention communicates with an additional information database for providing financial institutes' related information, such as but not limited to, real estate market prices, reversion rates, and investment return measurement including capitalization and discount rates, rental rates, rental changes, occupancy, vacancy, construction, market cycles, lease and purchase analytics, as requested by the user. The server then transmits back the generated financial calculation report to user display device in an easy to read and share report format which further enables the user to save, edit and share the generated information over the wireless communication network with other users.

### FIELD OF THE INVENTION

The present invention relates generally to a wireless financial calculation method and system, and more particularly, to a system and method for user defined financial calculation using a wireless communication device.

### BACKGROUND OF THE INVENTION

Financial calculations are an important part of our daily routine and very few people have strong mathematical background to efficiently and quickly perform all these required financial calculations. Property related financial calculations relating to loan amounts, interest rates, monthly installments, investment or lease property analysis, and property loan analysis etc. are not possible on fingertips and one has to follow complex mathematical formulas for carrying out such calculations.

Wireless communication devices have also changed the consumer and real estate professional's behavior and the real estate industry is interested in accessing and manipulating financial information through wireless and mobile devices quickly and easily. Further, many new technologies have become an integral part of our life and users have now become accustomed to rapid and easy access to data even when they are moving. Mobile phones are one of the technologies that have changed our day-to-day life and have become an easy to use tool for information extraction and presentation.

For instance, U.S. Pat. No. 7,130,810B2 outlines tools for property related online calculations using networked computer systems. The user has to use multiple databases for conducting all the calculations. The invention further uses number of tools for providing different online calculations.

For instance, U.S. Pat. No. 6,968,316 outlines a method, system and a computer program disclosing method, system and the computer program for calculating financial values. The system also provides a comparison and rating tool for assigning scores for financial analysis.

For instance, US patent number patent US20120303728A1 outlines a data collection and report generation system.

However, the disadvantage with current wireless financial calculation system and method is that they need either an expert to use them or a strong comprehension of finance. The user of these financial calculation systems also has to remember a number of values that the user has to input on the device prompt or before conducting the final calculation. These traditional financial calculation system and method also take a lot of time for data processing and calculation which further delays the final output.

Another disadvantage with the above mentioned solutions is that the user has to search on multiple databases which is often a time consuming job. Further, while using such traditional financial calculation method and system, the user has to search separately for the location information and then for the associated third party representative on different databases. Yet another disadvantage of the above-mentioned traditional solutions is that most of them are designed for a specific business or budget related use and the proposed solutions are not specifically designed for financial calculations related to real estate purchase, lease and loan.

Thus there is a need of a system and method that enables the user to quickly conduct complex financial calculations by wirelessly sending the request for calculating the desired financial information. There is also a need of a system and method that can produce a detailed document of the requested financial calculation. Further, there is a need of a system and method that can enable the user to save and share the said generated document for future use or consultation with other people.

### SUMMARY OF THE INVENTION

To solve the problems described above, the present invention provides following solutions.

In a preferred embodiment of the present invention there is provided a system and method for wireless financial calculation for a real estate property of user's interest. It involves receiving user request from a wireless communication device through a wireless communication network, wherein the received user request includes, but is not limited to, purchase price, potential income, vacancy credit loss, other income, expenses, loan amount, loan rate, loan amortization, cap rate at sale which are either selected or inputted through the wireless communication device. The system and method of the present invention submits the received user information to a remote server for conducting property related financial calculation, as requested by the user. The server submits the calculated property related financial calculation results back to the wireless user display device over a wireless network. In another preferred embodiment of the present invention, the user interface enables user to generate a financial calculation report in a user defined document format, such as, but not limited to, a portable document format (PDF), HTML, or other electronic document of the received financial calculation wherein the user can further define the hold period of the property ownership, lease, or loan for the financial calculation as conducted by the remote server.

In another embodiment of the present invention there is provided a system and method for conducting a wireless financial calculation related to real estate property of user's interest, directed to transmit the user request using a wireless communication device through a webservice request, such as but not limited to, JSON, XML, email or HTML created by the user display device comprising a user access verification data to validate user's access to a server and a location specific information. In a method of the present invention, the information request is transmitted to the remote server located at a secure location. In another method the server then conducts all of the requested financial calculations using preloaded financial calculation programs.

In another embodiment of the present invention, the wireless information request is received in the form of an image clicked from the built-in camera of the wireless communication device. The image includes photo geotagging, providing the location information of where the user captured the image and the system extracts the property related information automatically by searching in the additional property related information databases and then request the user to fill in the user related financial data.

In a further embodiment of the present invention, the user location is determined by using a global positioning system or the triangulated position of the user's display device.

In another embodiment of the present invention, the additional information database includes databases, such as but not limited to, third party information databases, geographic information systems (GIS), state or local agencies, local property administration and national government databases that have been created and compiled by other sources, such as but not limited to, the third party location advisors, geographic information systems, elements, property, imagery, state and local agencies. The additional information property database provides property related information, such as, but not limited to, real estate market prices, reversion rates, investment return measurement including capitalization and discount rates, rental rates, rental changes, occupancy, vacancy, construction, market cycles, lease and purchase analytics

In further embodiment of the present invention, the user interface of the wireless financial calculation system provides a share option to share the generated financial calculation report in a user defined document format, such as, but not limited to, a portable document format (PDF), HTML, or other electronic document using sharing platforms, such as, but not limited to email, paper printing and uploading to cloud or common access.

In another embodiment of the present invention, the user display device presents the transmitted information in an easy to read format, such as but not limited to, images, property layout, room images, property price, landmarks, pricing graphs as offered by different third party property advisors or the like.

Further features and advantages of the present invention, as well as the structure and operation of various embodiments of the present invention, are described in detail below with reference to the accompanying drawings.

### BRIEF DESCRIPTION OF THE DRAWINGS

For the purpose of illustration, there are shown in the drawings certain embodiments of the present invention wherein like reference numbers generally indicate identical, functionally similar, and/or structurally similar elements. It should be understood that the invention is not limited to the precise arrangements, dimensions, and instruments shown.

FIG. 1 depicts a wireless property related financial calculation system according to an exemplary embodiment of the present invention;

FIG. 2 depicts a wireless property related financial calculation system according to an exemplary embodiment of the present invention, showing selection options for generating different types of financial calculation reports;

FIG. 3 depicts a wireless property related financial calculation system according to an exemplary embodiment of the present invention showing financial data input options;

FIG. 4 depicts a flow diagram for wireless property related financial calculation system according to an exemplary embodiment of the present invention;

FIG. 5 depicts a wireless property related financial calculation system according to an exemplary embodiment of the present invention showing the save selection options, customized property name and/or address for data input regarding property ownership, lease or loan hold periods to be considered for financial calculation report generation;

FIG. 6 depicts a wireless property related financial calculation system according to an exemplary embodiment of the present invention showing hold period selection buttons;

FIG. 7 depicts processing of the submitted financial data by the remote server;

FIG. 8 depicts a financial calculation report format as defined by the user;

FIG. 9 depicts a user interface for selecting the sharing option; and

FIG. 10 depicts a user interface to share the generated financial calculation report via email.

### DETAILED DESCRIPTION OF THE INVENTION

In this section, some preferred embodiments of the present invention are described in detail sufficient for one skilled in the art to practice the present invention. It is to be understood, however, that the fact that a limited number of preferred embodiments are described herein does not in any way limit the scope of the present invention as set forth in the appended claims. It is also to be understood that a person skilled in the relevant art will recognize that other components and configurations can be used without parting from the spirit and scope of the invention.

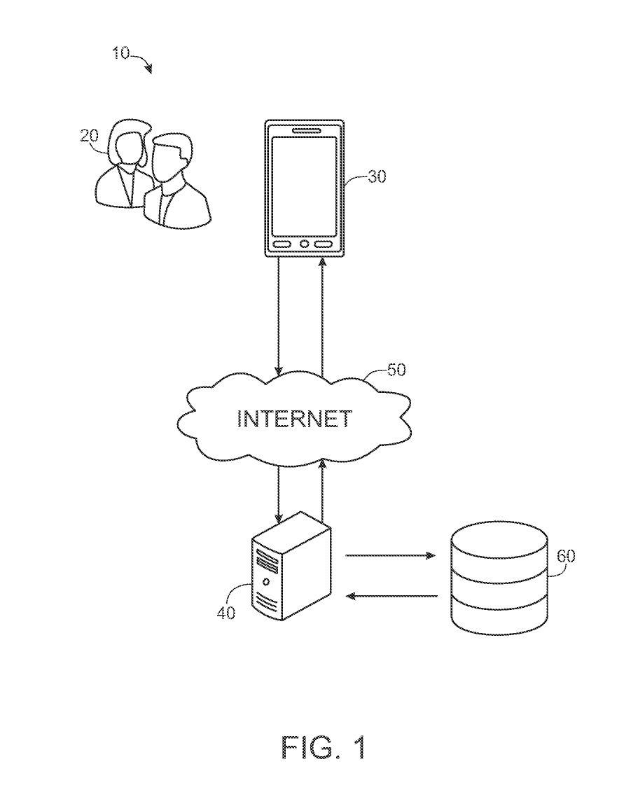

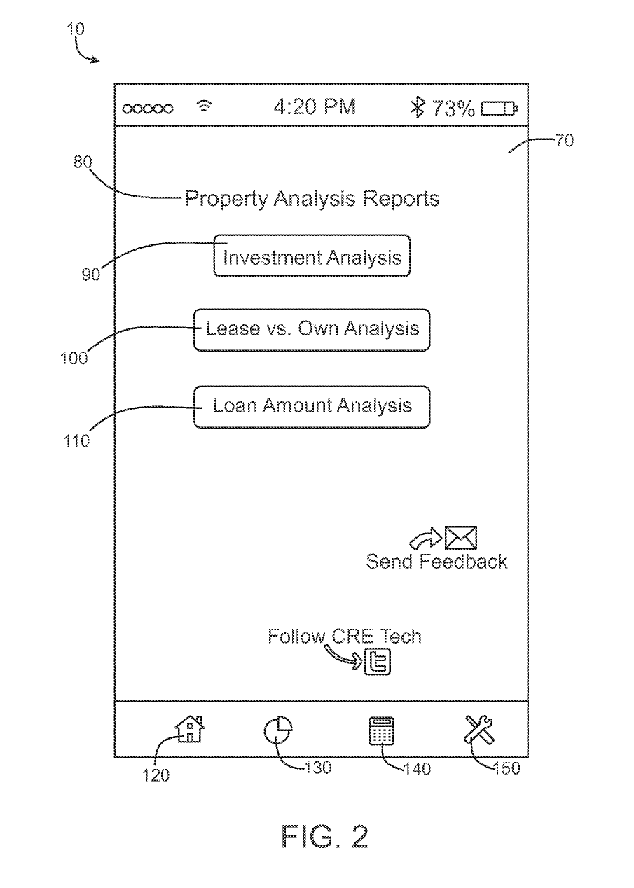

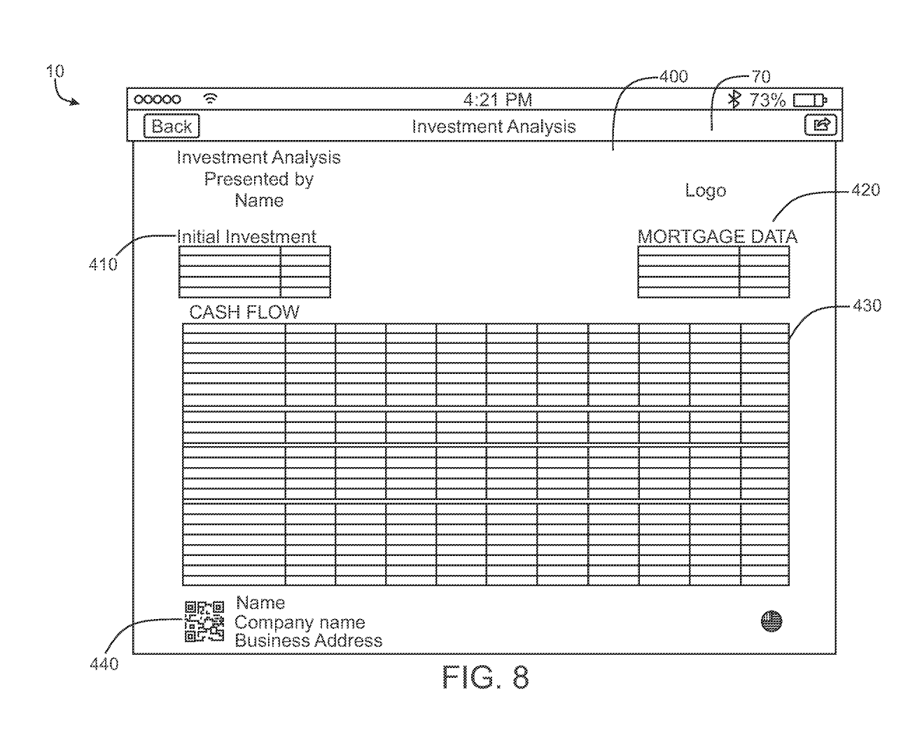

Referring to FIG. 1, there is shown a wireless financial calculation system 10 comprising a user 20, a wireless user display device 30, such as, but not limited to, smartphone, personal digital assistance, palmtop or laptop and a server 40. The wireless user display device 30 may comprise a global positioning system or the triangulated position determination means for determining and communicating the user's location. The wireless user display device 30 is using a wireless communication network 50 for transmitting and receiving information from a server 40 located at a secure location. The server 40 comprises pre-stored financial programs for conducting financial calculations as per user's 20 requests. The server 40 may also transmit and receive information from an additional information database 60, such as but not limited to, third party information databases, geographic information systems (GIS), state or local agencies, local property administration and national government databases which are already maintained for location specific information retrieval and presentation such as but not limited to, location, property, user, business, landmark, product, event or object. The additional information property database 60 provides property related information, such as but not limited to, real estate market prices, reversion rates, investment return measurement including capitalization and discount rates, rental rates, rental changes, occupancy, vacancy, construction, market cycles, lease and purchase analytics. The server 40 communicates with the additional information database 60 for extraction of the financial institutes' related additional information regarding the property of user's 20 interests. In a preferred embodiment of the present invention the wireless user display device 30 uses the wireless communication network 50 to transmit the property information, location information, and inputted financial information, such as, but not limited to, purchase price, potential income, vacancy credit loss, other income, expenses, loan amount, loan rate, loan amortization, capitalization rate at sale, directly to the server 40. As shown in FIG. 2, the wireless user display device 30 provides a user interface 70 to the user 20 for initiating the calculation for generating a financial calculation report 400 (as shown in FIG. 8) of user's 20 interest, such as, but not limited to, an investment analysis 90, a lease vs. loan financial analysis 100 and a loan amount analysis 110. The user interface 70 comprises a home selection button 120 for enabling user 20 to reach home screen of the wireless user display device 30, a graphical display selection button 130 to create graphical visualization of the generated detailed financial calculation of the collected property related information, a calculator selection button 140 for providing calculator to the user 20 for conducting property investment, rates of return, lease and loan calculations and a settings button 150 for enabling the user to edit the settings of the wireless financial calculation system 10.

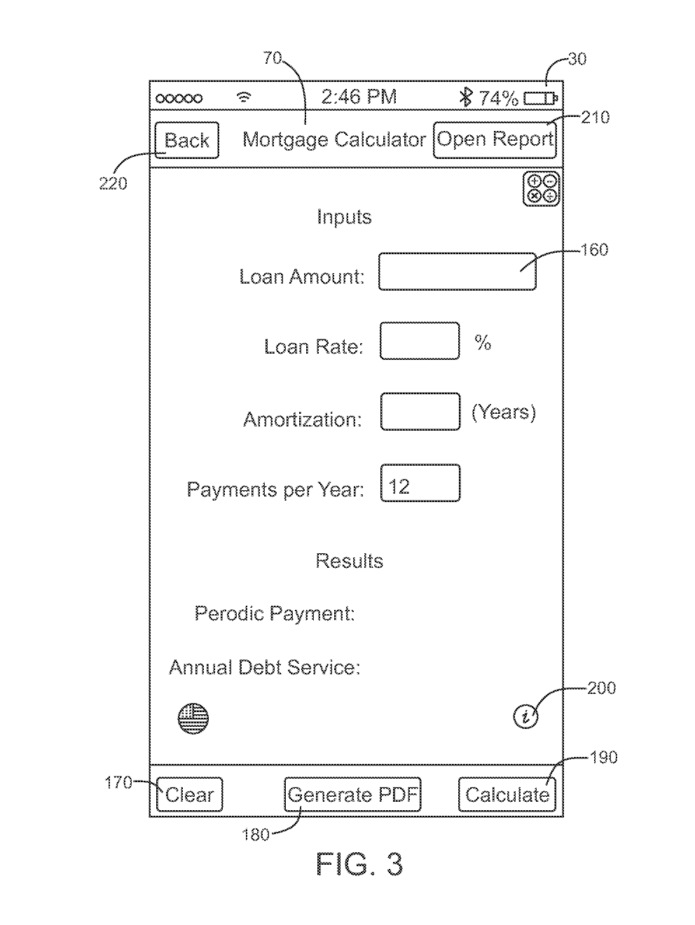

Referring to FIG. 3, there is shown an investment analysis interface 70 for collecting financial data, such as, but not limited to, purchase price, potential income, vacancy credit loss, other income, expenses, loan amount, loan rate, loan amortization, capitalization rate at sale, through financial data input field 160 related to property of user 20 interest. The investment analysis interface 70 further comprises a clear screen button 170 for removing all of the automatically extracted or inputted information, a generate report button 180 for generating requested financial calculation report 400 (as shown in FIG. 8) in a user defined document format, such as, but not limited to, a portable document format (PDF), HTML, or other electronic document, calculate request button 190 for conducting financial calculation as per the collected financial data, a help selection button 200 for providing assistance or help to user 10 while conducting the financial calculation, an open report button 210 for retrieving previously saved financial data by the user 20 and a back button 220 for returning back to previous screen.

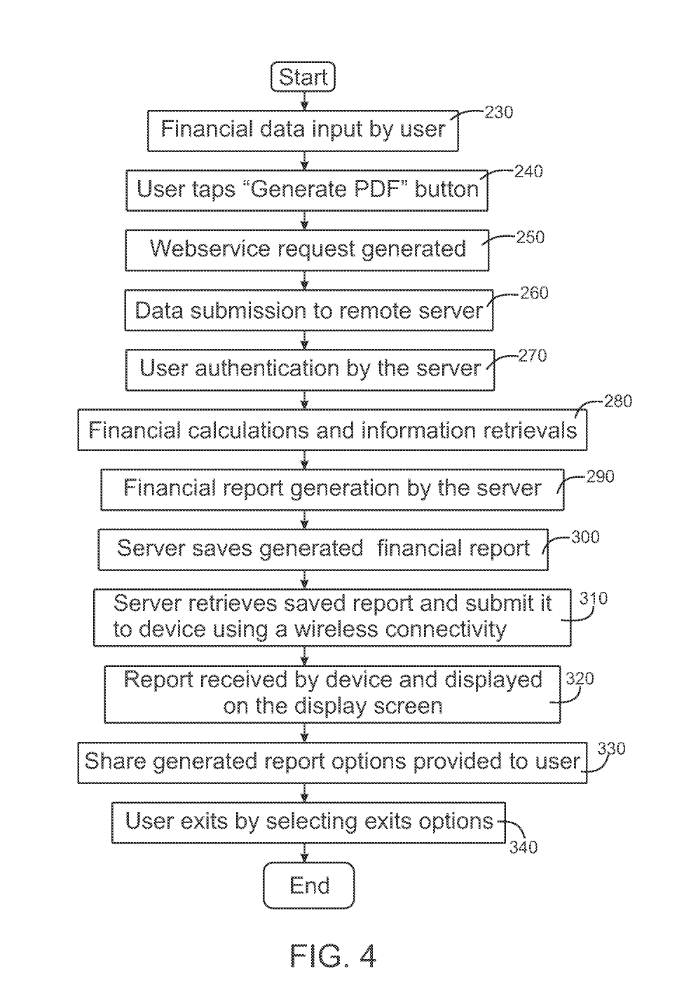

Referring to FIG. 4, there is shown a flow diagram of wireless property related financial calculation system. At block 230, the user 20 enters financial data, such as, but not limited to, purchase price, potential income, vacancy credit loss, other income, expenses, loan amount, loan rate, loan amortization, capitalization rate at sale into the data input fields as displayed on the user interface 70 of the wireless user display device 30. At block 240, the user taps on the generate report button 180 and the wireless user display device 30 starts validating the user data. At block 250, the property related financial calculation request is submitted through a wireless user display device 30 in the form of a webservice, such as but not limited to, JSON, email, XML or HTML. At block 260, in one method, the server 40 accepts the financial calculation request and starts processing the received request. At block 270, the server 40 parses the webservice request data and if the user 20 is authorized, the server 40 stores the submitted data for future use or retrieval by the registered user 20. At block 280, the server 40, starts generating the requested financial calculation by conducting requested calculations. The server 40 requests additional information from the linked additional information databases 60, including, but not limited to, real estate market prices, reversion rates, investment return measurement including capitalization and discount rates, rental rates, rental changes, occupancy, vacancy, construction, market cycles, lease and purchase analytics to be included on the financial calculation report 400 (as shown in FIG. 8). At block 290, the server 20 starts compiling the generated data and automatically creates the detailed financial calculation report 400 in the user defined document format, such as, but not limited to, a portable document format (PDF), HTML, or other electronic document. At block 300, the server 40 saves the created financial calculation report 400 in the user defined document format, such as, but not limited to a portable document format (PDF), HTML, or other electronic document, for future retrieval. At block 310, the server 40 retrieves the saved financial calculation report 400 and transmits it back to the user wireless display device 30 through a wireless communication network 50. At block 320, the wireless user display device 30 displays the created financial calculation report 400 to the user 20. At block 330, the user 20 accesses the document and then can print, email or upload the financial calculation report 400 to a sharing site. At block 340, the user 20 exits the user interface 70 and the system requests the user 20 for saving or deleting the generated financial calculation report 400.

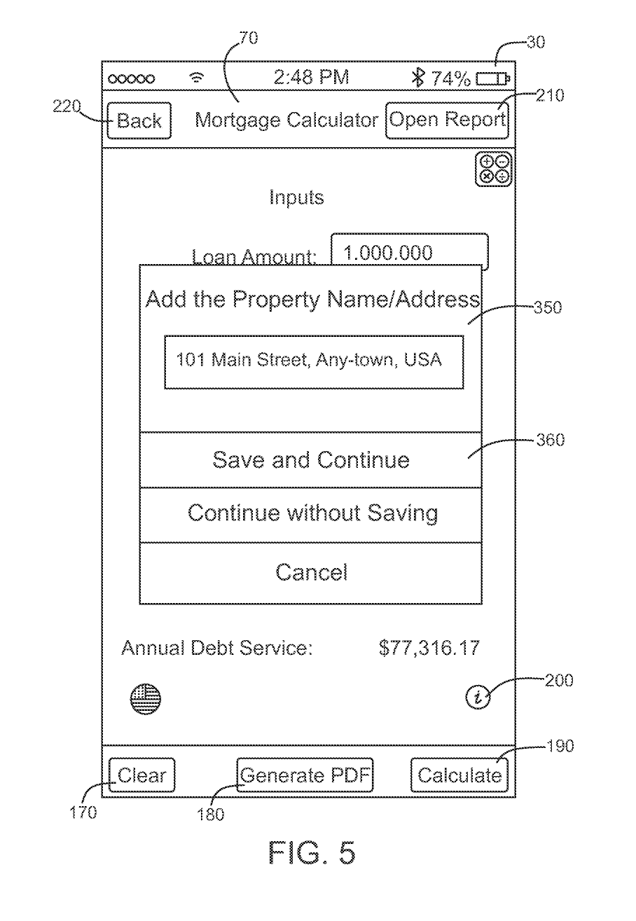

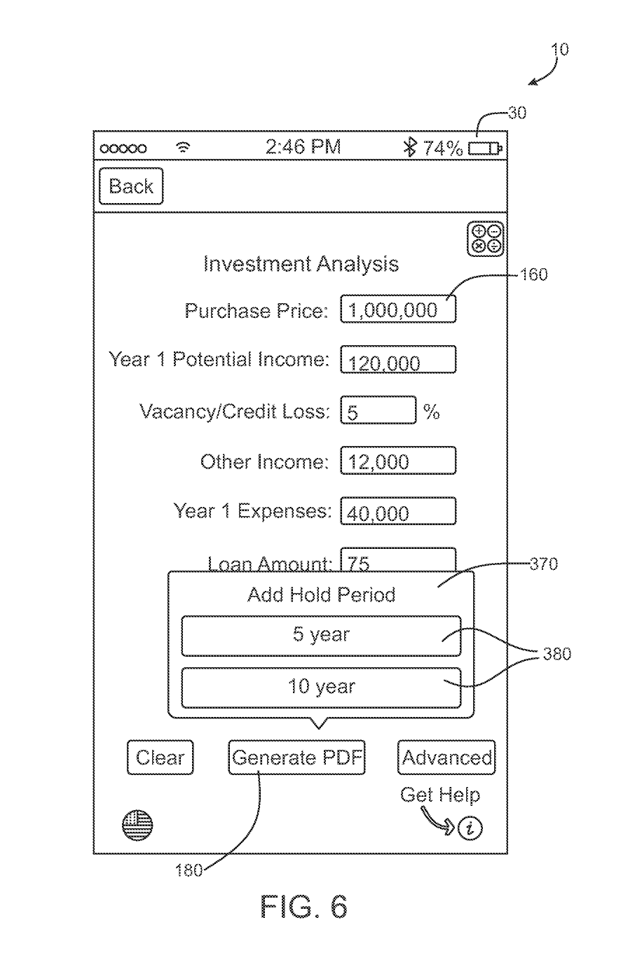

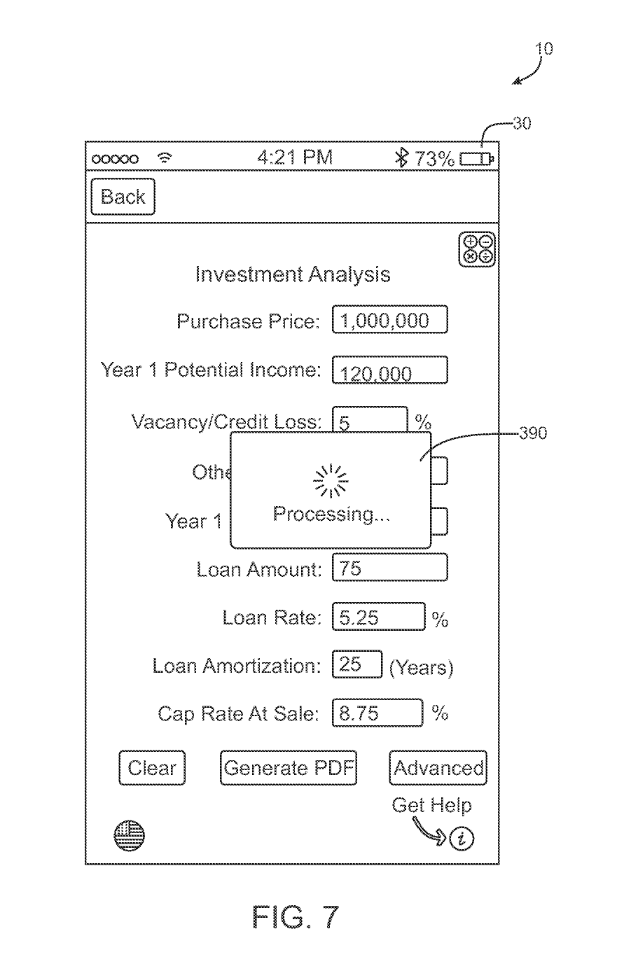

As shown in FIG. 5, on selection of financial calculation report generation button 180 for generating financial calculation report 400 in the user defined document format, such as, but limited to, a portable document format (PDF), HTML, or other electronic document, the system 10 asks user 20 for property name 350 and a selection option 360 to continue after saving, without saving or to cancel the property name input option. Further, as shown in FIG. 6, the system 10 asks user 20 for selecting a hold period 370 which further provides a time period selection buttons 380 for selecting the time period the user intends to own or lease the property, or the loan term for the intended property. Further, as shown in FIG. 7, after selecting time period button 380 by the user 20 the system 10 shows a processing icon 390 which depicts start of communication with the server 40 for conducting the financial calculation.

Referring to FIG. 8, there is shown the user interface 70 now displaying the financial calculation report 400. The financial calculation report 400 provides an initial investment details table 410, a mortgage data table 420 and a detailed cash flow table 430. The user interface 70 also displays a representative company contact information 440, including, but not limited to, a representative name, company name, business address and QR code at the bottom of the financial calculation report 400, in a user defined document format such as, but not limited to, a portable document format (PDF), HTML, or other electronic document.

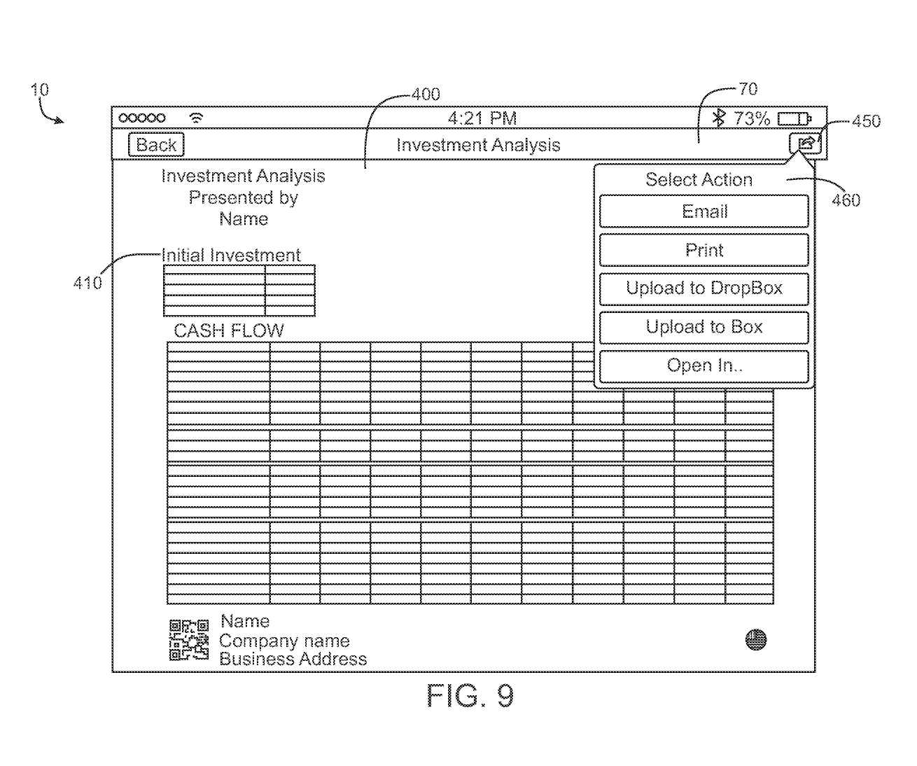

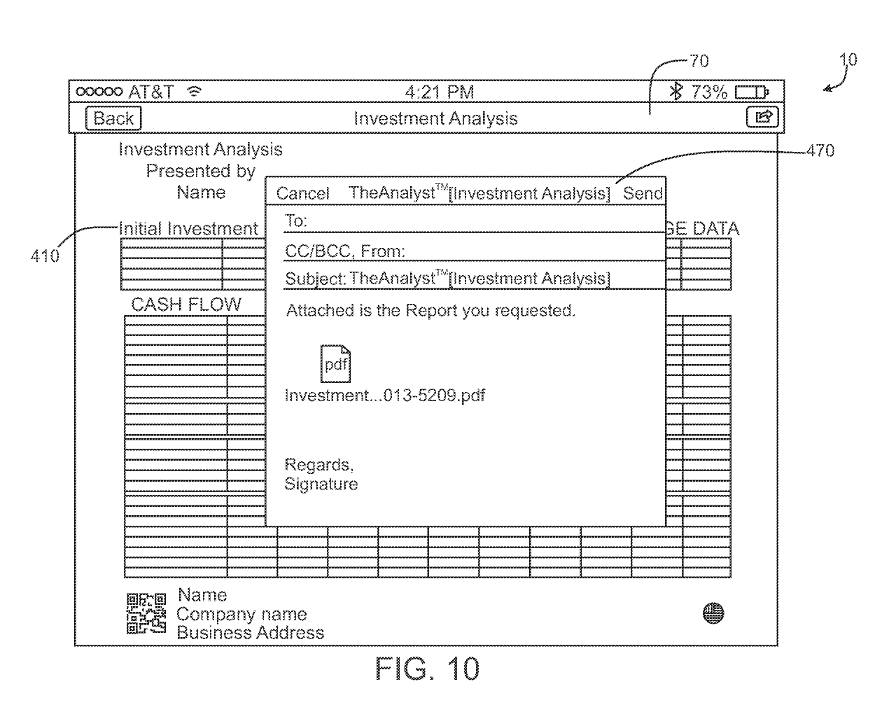

Referring to FIG. 9, there is shown another embodiment of the present invention. The user interface 70 provides a share information selection button 450 for sharing the generated financial calculation report 400 of a property related financial calculation. The share information selection button 450 further provides plurality of share option 460, such as, but not limited to, email, print, and upload of the information on a third party information sharing platform. Further, as shown in FIG. 10, there is shown a user interface 470 for sharing the generated financial calculation report 400 through email. When the user selects one of the share options through selection button 450, the user interface 70 provides another user interface 470 for sharing the generated financial calculation report 400 through email.

Although the present invention has been described in detail with reference to certain examples thereof, it may be also embodied in other specific forms without departing from the essential spirit or attributes thereof.

In addition, some embodiments of the present invention may be integrated with an information website or video broadcast system. That is, many location, property, user, business, landmark, product, event or object information websites already utilize a plurality of cameras and camera operators to provide live video broadcasts and property related information live display. These systems are designed to capture unpredictable live changes in the location, property, user, business, landmark, product, and event or object information, such as but not limited to, availability and price of the property or item. The present invention can take advantage of this pre-existing information databases and can avoid labor investment to provide information to the user 20.

The present invention and components thereof are also capable of being distributed as a program product in a variety of forms, and applies equally regardless of the particular type of user display device being used to actually carry out the wireless location information request.

The accompanying figures and this description depicted and described embodiments of the present invention, and features and components thereof. Accordingly, it is desired that the embodiments described herein be considered in all respects as illustrative, not restrictive, and that reference be made to the appended claims for determining the scope of the invention.

We claim:

1. A system for conducting property related financial calculations over a wireless network, comprising:
a wireless user display device;
a server located at a secure location;
a wireless communication network connecting the wireless user display device with the server; and
an additional information database for requesting additional information related to property of user's interest, wherein the additional information database is maintained by a third party connected to the server over the wireless communication network,
wherein the server comprises pre-stored lists of financial calculation program for conducting the requested financial calculation for the property of user's interest, and wherein the database provides real estate market prices, reversion rates, investment return measurement including capitalization and discount rates, rental rates, rental changes, occupancy, vacancy, construction, market cycles, lease and purchase analytics.

2. A system as in claim 1, wherein the wireless user display device can be a smartphone, tablet, personal digital assistance, palmtop or laptop.

3. A system as in claim 1, wherein the wireless user display device comprises a global positioning system or a triangulated position determination means for determining and communicating the user's location.

4. A system as in claim 1, wherein the server stores the submitted webservice user data in a database for future use or retrieval by the registered user.

5. A system as in claim 1, wherein the database comprises third party information databases, geographic information systems (GIS), state or local agencies, local property administration and national government databases.

6. A method for conducting property related financial calculations over a wireless network, comprising:
receiving user financial data through a user interface into a user wireless display device;
initiating financial analysis report generation by selecting the generate financial report option through the user interface on the user wireless display device;
validating user data and submitting validated user financial data to a server located at a secure location;
processing received user financial data by the server and requesting additional information from an additional information database;
compiling and generating user financial analysis report by the server in a user defined report format;
saving generated user financial analysis report on the server and retrieving saved user financial analysis report on user request from the server; and
transmitting the user financial report by the server to the user wireless display device.

7. A method as in claim 6, wherein the user financial data includes purchase price, potential income, vacancy credit loss, other income, expenses, loan amount, loan rate, loan amortization, capitalization rate at sale which are either selected or inputted through the wireless communication device.

8. A method as in claim 6, wherein the wireless user display device includes a user interface component, and wherein the user selects, through the user interface component, each of the financial calculation options and inputs the corresponding property financial data.

9. A method as in claim 8, wherein the user interface displays a plurality financial calculation options, such as but not limited to, an investment analysis, lease analysis, lease vs. own financial analysis, loan amount analysis, current and historic going-in and reversion capitalization rates, market rent, vacancy, expense and discount rates.

10. A method as in claim 9, wherein the user selects, through the user interface component, a home button to move back to home interface, a graphical display button for creating graphical display of the inputted financial information, a calculator button for conducting various calculations and a settings button to edit settings of the system.

11. A method as in claim 10, wherein the user interface displays a plurality of time period selection buttons for selecting the time period for which the user intends to own or lease the property, or the loan term for the intended property.

12. A method as in claim 11, wherein the user interface displays a share button, such as but not limited to, email, print, and upload of the information on a third party information sharing platform for sharing the generated reports of a property related financial calculation.

13. A method as in claim 12, wherein the user interface further displays a clear screen button for removing all of the automatically extracted or inputted information, a generate report button for generating a requested report in a predefined report format, calculation request button for conducting financial calculation as per the collected financial data, a help selection button for providing assistance or help to user while conducting the financial calculation, an open report button and a back button for returning back to previous screen.

14. A method as in claim 6, wherein the generated report format is a portable document format (PDF), HTML, other electronic document or a combination thereof.
